(19) United States
(12) Patent Application Publication
(10) Pub. No.: US 2025/0085619 A1
(43) Pub. Date: Mar. 13, 2025

(54) MOUNTING DEVICE FOR A CAMERA

(71) Applicant: iPEK International GmbH, Sulzberg (DE)

(72) Inventors: Martin Schwarz, Kempten (DE); Sebastian Felder, Hirschegg (AT); Alexander Stoll, Oberreute (DE)

(21) Appl. No.: 18/883,926

(22) Filed: Sep. 12, 2024

(30) Foreign Application Priority Data
Sep. 13, 2023 (DE) 10 2023 124 722.0

(51) Int. Cl. G03B 17/56; F16L 55/40

(52) U.S. Cl. CPC G03B 17/561; F16L 55/40

(57) ABSTRACT

The invention relates to a mounting device for detachably mounting a device on a crawler of a sewer inspection and/or maintenance system, wherein the mounting device has a rear side and a front side, wherein the mounting device has
a largely vertical lower portion,
a largely vertical upper portion, and
a sloping middle portion,
   wherein the upper portion is arranged offset rearwards or forwards by a predetermined offset relative to the lower portion.

### CROSS-REFERENCE TO RELATED APPLICATIONS

This application claims priority to German Patent Application Serial No. DE 10 2023 124 722.0, filed Sep. 13, 2023, the entire disclosure of which is hereby incorporated herein by reference in its entirety.

### FIELD OF THE INVENTION

The invention relates to a mounting device for detachably mounting a camera on a crawler of a sewer inspection and/or maintenance system and to a crawler of a sewer inspection and/or maintenance system with a mounting device for detachably mounting a camera on the crawler.

### BACKGROUND OF THE INVENTION

When inspecting sewers that have a so-called egg-shaped profile, there is an increased risk that inspection equipment, e.g., a crawler with an inspection camera arranged thereon, will tip sideways. In order to prevent tipping over, it is known to equip the crawler with a so-called egg-shaped profile adapter. FIG. 1 shows a sewer 60 having an egg-shaped profile. A crawler 30, on which an egg-shaped profile adapter 50 is arranged, is located in the sewer 60. The egg-shaped profile adapter 50 has arms, which protrude to the left and right and at the free ends of which there are guide wheels which rest on the inner wall of the sewer.

However, such egg-shaped profile adapters have several disadvantages.

The egg-shaped profile adapters are structurally complex, since it must be possible to extend or swivel out the arms sideways in order to place the guide wheels on the inner wall of the sewer. Hydraulic actuators are usually used for this purpose. The egg-shaped profile adapters are therefore usually very heavy.

When driving past side inlets of the sewer, the guide wheels can project into these side inlets. The center of gravity of the entire system is shifted significantly upwards due to the high weight of the egg-shaped profile adapter, and the sideways protruding arms with the guide wheels arranged thereon result in the entire system becoming unstable. However, both can significantly facilitate the engagement of the guide wheels in the side inlet, since the entire system can tip significantly more easily in the direction of the side inlet. This creates the risk that the guide wheels will become caught in the side inlet. In addition, when driving through a manhole passage, which usually does not have an egg-shaped profile, there is a risk of the system tipping due to the instability facilitated by the egg-shaped profile adapter.

The egg-shaped profile adapters are usually adapted to the crawler used, so that egg-shaped profile adapters adapted to the various crawlers must also be kept in stock.

### OBJECT OF THE INVENTION

The object of the present invention is therefore to provide a solution which avoids the aforementioned disadvantages and yet makes a safe and simple inspection of sewers having an egg-shaped profile possible.

### SUMMARY OF THE INVENTION

This object is achieved with a mounting device for detachably mounting a camera on a crawler of a sewer inspection and/or maintenance system and with a crawler of a sewer inspection and/or maintenance system with a mounting device according to the invention according to the independent claims. Advantageous embodiments of the invention are set forth in the specific dependent claims.

Accordingly provided is a mounting device for detachably mounting a device on a crawler of a sewer inspection and/or maintenance system, wherein the mounting device has a rear side and a front side, wherein the mounting device has
a largely vertical lower portion,
a largely vertical upper portion, and
a sloping middle portion,
   wherein
the middle portion connects the lower portion to the upper portion,
the upper portion is arranged offset rearwards or forwards by a predetermined offset relative to the lower portion,
a first adapter, by means of which the mounting device is detachably mountable directly or indirectly on the crawler, is arranged on the rear side and/or on the front side of the lower portion, and
a second adapter, on which the device is detachably mountable on the mounting device, is arranged on the front side and/or on the rear side of the upper portion.

Directly detachably mountable on the crawler means that the mounting device can be mounted directly on the crawler.

Indirectly detachably mountable on the crawler means that at least one unit, which is mounted on the crawler on one side, and on which the mounting device can be mounted on the other side, is provided between the mounting device and the crawler. An example of such a unit is a lifting arm, which is mounted on the crawler (possibly detachably), wherein the mounting device is mountable on the free end of the lifting arm.

The largely vertical lower portion, the largely vertical upper portion, and the sloping middle portion together form a basic structure.

The first adapter and the second adapter may each have connectors, wherein the connectors of the first adapter are routed to the connectors of the second adapter.

The mounting device may have at least two first support rods, wherein
the one first support rod projects beyond the profile of the mounting device on the left side of the mounting device, and
the other first support rod projects beyond the profile of the mounting device on the right side of the mounting device.

The mounting device may optionally have at least two second support rods, wherein
the second support rod on the left side of the mounting device projects beyond the profile of the mounting device, and
the other second support rod projects beyond the profile of the mounting device on the right side of the mounting device.

It is advantageous if the second support rods are each arranged at a predetermined vertical distance below the first support rods on the mounting device.

It is also advantageous if the second support rods project less beyond the profile of the mounting device than the first support rods.

The first support rods and/or the second support rods can be designed to be bendable and can have a predetermined restoring force.

The mounting device can be produced in a lightweight construction.

The second adapter can be pivoted about a pivot axis from the front side to the rear side of the upper portion, preferably by at least 180°. The pivot axis may be a vertical axis or a transverse axis.

It is advantageous if the pivot axis is assigned a controllable actuator, by means of which the second adapter can be pivoted.

The device may comprise an inspection unit, in particular an inspection camera.

Furthermore provided is a crawler of a sewer inspection and/or maintenance system with a mounting device according to the invention detachably mounted directly or indirectly on the crawler.

The crawler may have a connection unit, which corresponds to the first adapter of the mounting device, in order to detachably mount the mounting device on the connection unit.

Alternatively or additionally, the crawler may comprise a lifting unit, at the free end of which a connection module is provided, which corresponds to the first adapter of the mounting device in order to detachably mount the mounting device on the connection module.

### BRIEF DESCRIPTION OF THE DRAWINGS

Further details and features of the invention as well as specific, in particular advantageous, exemplary embodiments of the invention will be apparent from the following description in conjunction with the drawing. In the figures:

FIG. 1 shows a prior-art system with an egg-shaped profile adapter;

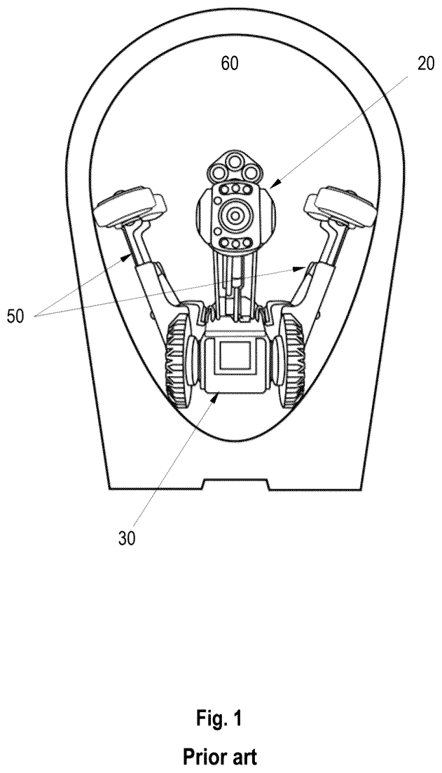

FIG. 2 shows a mounting device according to the invention for detachably mounting a camera on a crawler in a perspectival view;

FIGS. 3A-3C show the mounting device shown in FIG. 2, in a side view, a plan view, and a front view;

FIG. 4 shows an alternative embodiment of a mounting device according to the invention in a side view;

FIG. 5 shows a mounting device according to the invention with a first possibility for mounting on a crawler;

FIG. 6 shows a mounting device according to the invention with a second possibility for mounting on a crawler; and

FIG. 7 shows a mounting device according to the invention with a possibility for mounting on a lifting device of a crawler.

### DETAILED DESCRIPTION OF THE INVENTION

The mounting device according to the invention for detachably mounting a camera on a crawler of a sewer inspection and/or maintenance system can advantageously be used to inspect sewers having an egg-shaped profile. The inspection is also made considerably easier.

The shape of the mounting device, where applicable in combination with a lightweight construction, ensures that the center of gravity of the sewer inspection and/or maintenance system is not significantly changed in comparison to a sewer inspection and/or maintenance system without a mounting device according to the invention. This means that the stability of the sewer inspection and/or maintenance system is not negatively affected by the mounting device.

The use of a mounting device according to the invention also makes the use of a conventional egg-shaped profile adapter superfluous, while nevertheless effectively preventing the system from tipping over, on the one hand due to the low center of gravity, and on the other due to the use of bendable or flexible support rods.

The support rods also have the advantage that they do not get caught when engaging in a side inlet of the sewer. In addition, the support rods can be designed to be detachable and thus replaceable so that the dimensions of the support rods can be adapted in a simple manner to the dimensions of the sewer to be inspected.

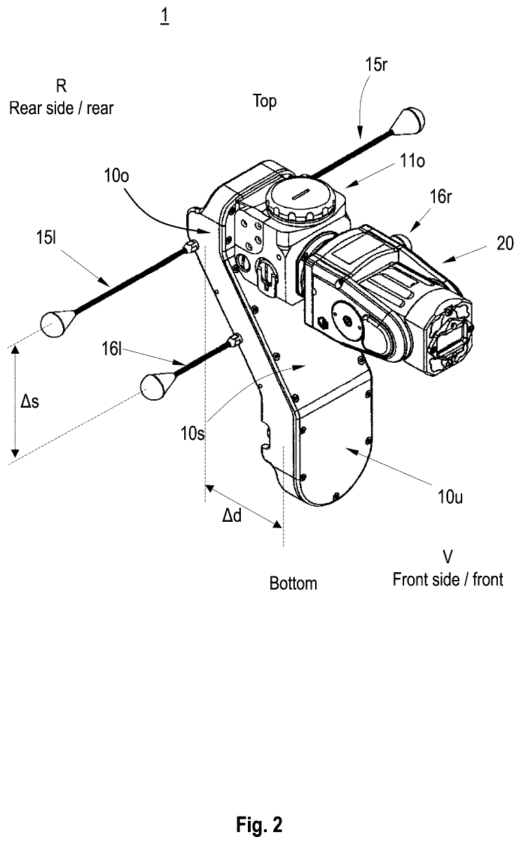

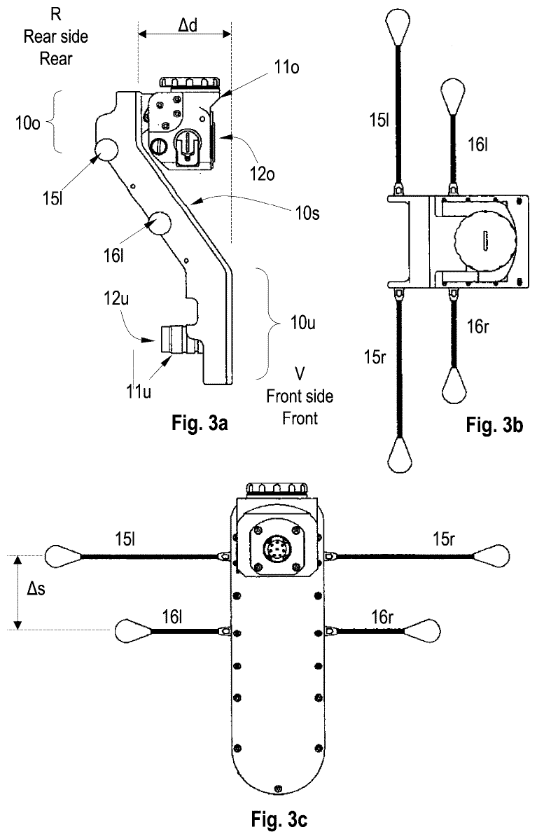

FIG. 2 and FIGS. 3A-3C show a mounting device 1 according to the invention for detachably mounting a camera 20 on a crawler (not shown here), wherein the mounting device is shown in a perspectival view in FIG. 2 and in a side view (FIG. 3A)), in a top view (FIG. 3B)), and in a front view (FIG. 3C)).

The mounting device 1 has a rear side R and a front side V and essentially comprises three portions, which form a basic structure of the mounting device, viz.,
a largely vertical lower portion 10u,
a largely vertical upper portion 10o, and
a sloping middle portion 10s,
   wherein the middle portion 10s connects the lower portion 10u to the upper portion 10o.

All three portions and thus the basic structure can be produced in a lightweight construction. For example, the basic structure can have a rib-like, honeycomb-like, and/or lattice-like structure, wherein the structure is chosen such that the required stability and strength are met. With regard to materials, lightweight construction materials can be used—for example, fiber-reinforced plastic such as carbon-fiber-reinforced plastic or glass-fiber-reinforced plastic. As a result, the center of gravity of the system on which the mounting device is used is not or only insignificantly changed by the mounting device, such that the mounting device has almost no or only a negligible effect on the stability of the sewer inspection and/or maintenance system in the sewer. In addition, the drive units of the crawler can be protected, since only a very small additional weight has to be carried with the mounting device according to the invention.

A first adapter 11u, by means of which the mounting device is detachably mountable on the crawler 30 or on a lifting device of the crawler, is provided or arranged on the rear side R of the lower portion 10u. The first adapter 11u is preferably designed such that the mounting device can be mounted on the crawler or on the lifting device without tools and can be detached from the crawler or from the lifting device without tools.

In one embodiment of the invention, a first adapter 11u can alternatively be provided or arranged on the front side V of the lower portion 10u.

In a further embodiment of the invention, a first adapter 11u in each case can be provided or arranged both on the rear side R and on the front side V of the lower portion 10u. This increases the flexibility with regard to the mounting on a crawler.

A second adapter 11o, on which an inspection unit, in particular a camera 20, is detachably mountable on the mounting device, is arranged on the front side V of the upper portion 10o. Here too, the second adapter 11o is preferably designed such that the inspection unit can be mounted on the mounting device without tools and can be detached from the mounting device without tools.

Alternatively, the second adapter 11o can also be arranged on the rear side R of the upper portion 10o.

In a further embodiment of the invention, a second adapter 11o in each case can be provided or arranged both on the rear side R and on the front side V of the upper portion 10o. This increases the flexibility with regard to the mounting of an inspection unit on the mounting device.

The upper portion 10o is arranged offset rearwards by a predetermined offset Δd relative to the lower portion 10u. Alternatively, the upper portion 10o may be arranged offset forwards by a predetermined offset Δd relative to the lower portion 10u. The direction of the offset depends substantially upon the specific requirements, in particular upon the desired horizontal position of the inspection unit relative to the crawler.

The first adapter 11u and the second adapter 11o each have connectors 12u, 12o, wherein the connectors 12u of the first adapter 11u are routed to the connectors 12o of the second adapter 11o—for example, by means of electrical lines. These lines can run or be arranged in the basic structure, preferably in a closed conduit of the basic structure. The connectors of the first adapter 11u correspond to the connectors of the second adapter 11o.

In one embodiment of the invention, the mounting device has two first support rods 15l, 15r, wherein these support rods are arranged on the basic structure. The first support rods can be detachably mounted on the basic structure (for example, by means of screws) so that they can be removed or replaced by other support rods as needed.

The one first support rod (15l) is arranged on the basic structure or on the mounting device such that it projects beyond the profile of the mounting device (as can be clearly seen in particular in FIG. 3C). The other first support rod (15r) is arranged on the basic structure or on the mounting device such that it projects beyond the profile of the mounting device (as can be clearly seen in particular in FIG. 3C). According to one embodiment of the invention, the first support rods (15l, 15r) can each be mounted on the left or right side of the base support.

The dimensions of the first support rods 15l, 15r are selected such that they each project laterally beyond the crawler on which the mounting device is mounted. In a sewer having an egg-shaped profile, the free ends of the first support rods 15l, 15r thus project close to the inner wall of the sewer or touch the inner wall of the sewer. This prevents the inspection system from tipping in a sewer having an egg-shaped profile. Depending upon the dimensions of the sewer having an egg-shaped profile, shorter or longer first support rods 15l, 15r can be used.

The mounting device can have two second support rods 16l; 16r, as in the embodiment according to FIG. 2 and FIG. 3. The one second support rod 16l is arranged on the mounting device such that it projects beyond the profile of the mounting device on the left side of the mounting device. The other second support rod 16r is arranged on the mounting device such that it projects beyond the profile of the mounting device on the right side of the mounting device. With the second support rods 16l; 16r in combination with the first support rods 15l 15r, the inspection system tipping over in a sewer having an egg-shaped profile can be even better prevented.

The second support rods 16l; 16r are each arranged at a predetermined vertical distance Δs below the first support rods 15l; 15r (i.e., below the respective first support rod) on the mounting device. It may be advantageous if the second support rods 16l, 16r project less beyond the profile of the mounting device than the first support rods 15l, 15r. In a sewer having an egg-shaped profile, the second support rods arranged further down thus project substantially the same distance from the inner wall of the sewer as the two first support rods arranged further up.

In the simplest case, the length of the support rods can be defined by the extent to which the respective support rods extend beyond the profile of the mounting device.

In the embodiment of the invention shown in FIG. 2 and FIG. 3, the two first support rods are arranged at the transition from the middle portion 10s to the upper portion 10o; the two second support rods are arranged below them at the middle portion 10s. The first support rods and the second support rods are thus arranged at a certain horizontal offset to one another, which can be advantageous in terms of tipping safety, since a torque about a vertical axis of the system during tipping can thus be avoided to the greatest extent.

The first support rods 15l, 15r and/or the second support rods 16l, 16r are designed to be bendable, and advantageously have a predetermined restoring force. For example, the support rods can have a flexible plastic that allows a certain amount of bending of the support rods without them breaking. For example, if the inner wall of the sewer has an obstacle (for example, a deposit), a support rod can yield while passing, and overcome the obstacle without the crawler being tilted. After overcoming the obstacle, the support rod can straighten itself again.

At their free ends, the support rods here each have a knob-like end piece, which is preferably made of an abrasion-resistant plastic. This ensures that, when the support rods touch the inner wall of the sewer, they slide over the inner wall without getting caught. Preferably, the end pieces are detachably mounted on the respective support rod.

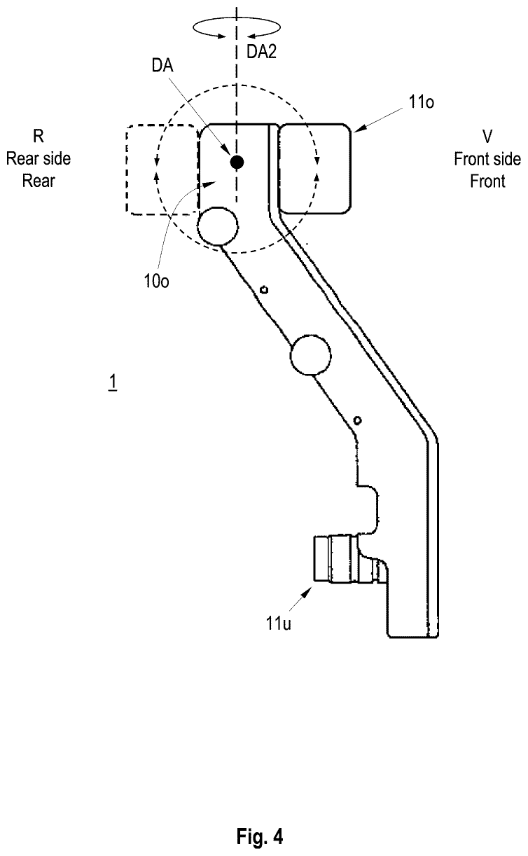

FIG. 4 shows an alternative embodiment of a mounting device 1 according to the invention in a side view.

The second adapter 11o is arranged on the front side V of the upper portion 10o. This adapter 11o can be pivoted about a rotation axis DA, which runs transversely to the mounting device, from the front side V to the rear side R of the upper portion 10o, wherein the pivot angle is preferably at least 180°. This allows an inspection unit, e.g., a camera, to be used as a front-facing inspection unit if the adapter 11o is arranged on the front side. However, the same inspection unit can also be used as a rear-facing inspection unit if the adapter 11o is pivoted by 180° rearwards, i.e., to the rear side R. One and the same camera can thus be selectively used as a rear view camera or as a normal, front-facing camera.

The second adapter 11o can be pivoted upwards to the rear side R. However, it is also possible to pivot the second adapter 11o downwards to the rear side R if the upper portion 10o and, where applicable, also the middle portion 10s are accordingly designed to allow pivoting through.

Alternatively, the second adapter 11o may also be pivotable about a vertical rotation axis DA2 from the front side V to the rear side R of the upper portion 10o, wherein the pivot angle here too is preferably at least 180°.

In a further embodiment (not shown here) of the mounting device 1 according to the invention, the upper portion 10o can be rotatable relative to the middle portion 10s, preferably about the vertical rotation axis DA2.

It is advantageous if the rotation axis DA or the vertical rotation axis DA2 is assigned a controllable actuator by means of which the pivoting process can be accomplished. The controllable actuator can be coupled to a control unit of the crawler, wherein the supply of the actuator with electrical energy and, where applicable, a data transmission between the control unit and the actuator can be handled via power and data lines routed from the first adapter 11u to the second adapter 11o.

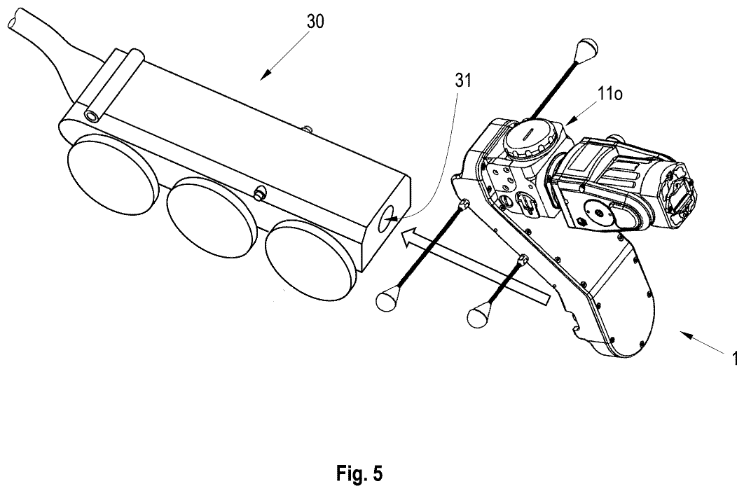

FIG. 5 shows a mounting device 1 according to the invention with a first possibility for mounting on a crawler 30.

On its front side, the crawler 30 has a connection unit 31, which corresponds to the first adapter 11u of the mounting device 1 and to which the adapter 11u can be connected. The connectors of the connection unit 31 are coupled to the second adapter 11o via the connection unit 31 and the first adapter 11u.

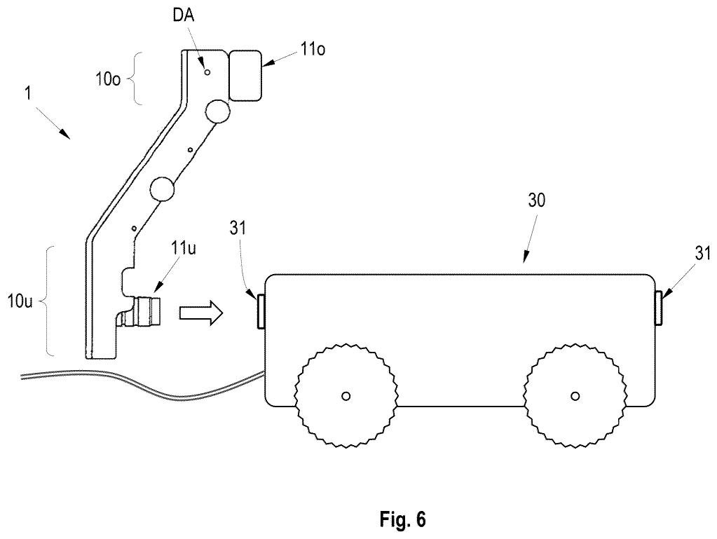

FIG. 6 shows a mounting device 1 according to the invention with a second possibility for mounting on a crawler 30.

On its rear side, the crawler 30 has a connection unit 31, which corresponds to the first adapter 11u of the mounting device 1 and to which the first adapter 11u can be connected. In contrast to the embodiment shown in FIG. 5, the second adapter 11o is not arranged on the rear side of the upper portion 10o, but on the front side of the upper portion 10o, so that a camera connected to the second adapter 11o can be used as a front-facing camera, although the mounting device is mounted on the rear end of the crawler. Optionally, as described with reference to FIG. 4, the second adapter 11o can also be pivotable about a rotation axis DA or about a vertical rotation axis DA2.

The crawler 30 can also have a connection unit 31 on its front side so that the mounting device 1 can also be connected there as needed.

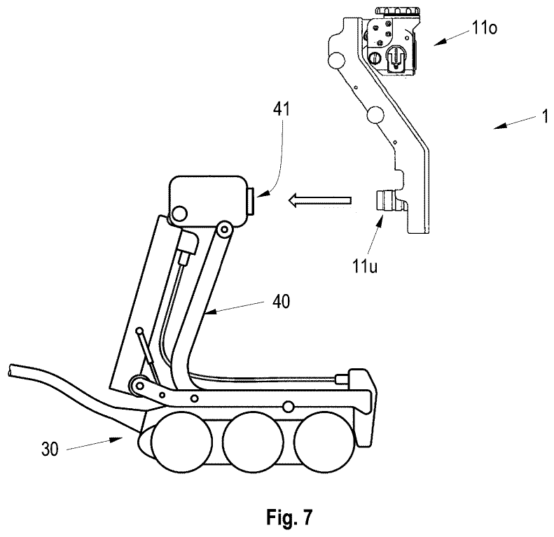

FIG. 7 shows a mounting device 1 according to the invention with a possibility for mounting on a lifting device 40 of a crawler 30.

The lifting device 40 is designed here as a lifting arm that can be deflected upwards about a rotation axis. At the free end of the lifting arm 40, a connection module 41 is arranged, to which the mounting device 1 can be connected by means of its first adapter 11u. The connectors of the connection module 41 correspond to the connectors 12u of the first adapter 11u.

Even if the mounting device 1 is used on a lifting device 40, the second adapter 11o can be pivotable about a rotation axis DA or about a vertical rotation axis DA2. In addition, here too, the first adapter 11u can be arranged on the front side V of the lower portion 11u instead of on the rear side R of the lower portion 1u. The same applies to the second adapter 11o arranged on the front side V of the upper portion 10o, provided that the second adapter 11o is not pivotable.

The use on a lifting device 40 has the advantage that a camera arranged on the mounting device 1 can be brought to a desired height in the sewer (can, for example, be centered in the sewer). The lengths of the first support rods 15l, 15r and, where applicable, of the second support rods 16l, 16r can be selected such that they are optimal for use with a centered camera. This means that, if the camera is arranged centrally in the sewer, the support rods each reach to the inner wall of the sewer. Nevertheless, the lifting arm 40 and thus also the mounting device 1 arranged thereon can be lowered as needed, since the support rods have a certain flexibility and can then bend upwards if necessary.

We claim:

1. A mounting device for detachably mounting a device on a crawler of a sewer inspection and/or maintenance system, wherein the mounting device has a rear side and a front side, wherein the mounting device has
a largely vertical lower portion,
a largely vertical upper portion, and
a sloping middle portion,
wherein
the middle portion connects the lower portion to the upper portion,
the upper portion is arranged offset rearwards or forwards by a predetermined offset relative to the lower portion,
a first adapter, by means of which the mounting device is detachably mountable directly or indirectly on the crawler, is arranged on the rear side and/or on the front side of the lower portion, and
a second adapter, on which the device is detachably mountable on the mounting device, is arranged on the front side and/or on the rear side of the upper portion.

2. The mounting device according to the preceding claim 1, wherein the first adapter and the second adapter each have connectors, wherein the connectors of the first adapter are routed to the connectors of the second adapter.

3. The mounting device according to claim 1, wherein the mounting device has at least two first support rods, wherein
the one first support rod projects beyond the profile of the mounting device on the left side of the mounting device, and
the other first support rod projects beyond the profile of the mounting device on the right side of the mounting device.

4. The mounting device according to claim 3, wherein the mounting device has at least two second support rods, wherein
the one second support rod projects beyond the profile of the mounting device on the left side of the mounting device, and
the other second support rod projects beyond the profile of the mounting device on the right side of the mounting device.

5. The mounting device according to claim 4, wherein the second support rods are each arranged at a predetermined vertical distance below the first support rods on the mounting device.

6. The mounting device according to claim 4, wherein the second support rods project less beyond the profile of the mounting device than the first support rods.

7. The mounting device according to claim 3, wherein the first support rods and/or the second support rods are designed to be bendable and have a predetermined restoring force.

8. The mounting device according to claim 1, wherein the mounting device is produced in a lightweight construction.

9. The mounting device according to claim 1, wherein the second adapter can be pivoted about a pivot axis from the front side to the rear side of the upper portion, preferably by at least 180°.

10. The mounting device according to claim 1, wherein the device comprises an inspection unit, in particular an inspection camera.

11. A crawler of a sewer inspection and/or maintenance system comprising with a mounting device detachably mounted directly or indirectly on the crawler, wherein the mounting device has a rear side and a front side, and wherein the mounting device has
a largely vertical lower portion,
a largely vertical upper portion, and
a sloping middle portion,
wherein
the middle portion connects the lower portion to the upper portion,
the upper portion is arranged offset rearwards or forwards by a predetermined offset (Δd) relative to the lower portion,
a first adapter, by means of which the mounting device is detachably mountable directly or indirectly on the crawler, is arranged on the rear side and/or on the front side of the lower portion, and
a second adapter, on which the device is detachably mountable on the mounting device, is arranged on the front side and/or on the rear side of the upper portion.

12. The crawler according to claim 11, wherein the crawler has a connection unit which corresponds to the first adapter of the mounting device in order to detachably mount the mounting device on the connection unit.

13. The crawler according to claim 11, wherein the crawler has a lifting unit, at the free end of which a connection module is provided, which corresponds to the first adapter of the mounting device in order to detachably mount the mounting device on the connection module.
